(19) United States
(12) Patent Application Publication
(10) Pub. No.: US 2022/0063046 A1
(43) Pub. Date: Mar. 3, 2022

(54) ENHANCED RAIL GRINDING SYSTEM AND METHOD THEREOF

(71) Applicant: Loram Maintenance of Way, Inc., Hamel, MN (US)

(72) Inventor: Thomas I. Bales, Stillwater, MN (US)

(73) Assignee: Loram Maintenance of Way, Inc., Hamel, MN (US)

(21) Appl. No.: 17/299,913

(22) PCT Filed: Dec. 4, 2019
(86) PCT No.: PCT/US19/64466

§ 371 Date: Jun. 4, 2021

Related U.S. Application Data
(60) Provisional application No. 62/774,984, filed on Dec. 4, 2018.
(60) Provisional application No. 62/775,165, filed on Dec. 4, 2018.

(51) Int. Cl. B24B 19/00; B24B 49/12; E01B 31/17; G06F 16/538; G06F 16/535; G06T 7/00; G06T 19/00

(52) U.S. Cl. CPC B24B 19/004; B24B 49/12; E01B 31/17; G06T 19/006; G06F 16/535; G06T 7/0002; G06F 16/538

(57) ABSTRACT

Systems and methods for a first rail grinding machine and a second rail grinding machine can be used to enhance specialized rail grinding. A first rail grinding machine can detect, process, and communicate a portion of track rail needing specialized grinding to a second rail grinding machine that can process and display a detected portion of rail requiring specialized rail grinding and display the portion of rail as a virtual image to an operator. A displayable image allows an operator to perform specialty rail grinding without the need to be physically present at the location for specialized rail grinding.

### PRIORITY CLAIM

The present application claims priority to U.S. Provisional Application Ser. Nos. 62/774,984 and 62/775,165, both of which are entitled “ENHANCED RAIL GRINDING SYSTEM AND METHOD THEREOF”, and both of which were filed on Dec. 4, 2018, the disclosures of which are hereby incorporated by reference in their entirety.

### TECHNICAL FIELD

This invention relates to rail grinding systems and related methods of performing grinding operations on railroad track rail surfaces. In particular, the present invention relates to a rail grinding system utilizing a first rail grinding machine to detect, identify and communicate locations requiring specialized rail grinding to a second specialized rail grinder.

### BACKGROUND

Railroad track rails are subject to wear by the passage of trains over the rails. In particular, depressions or pitting in the upper surface of a rail may develop such that the rail head presents an undulating, corrugated surface. Moreover, the rail may develop burrs, or otherwise lose its symmetrical profile. Maintenance of smooth running surfaces on railroad track rails is important for reasons of safety, riding comfort, protection of the track, track bed and rolling stock, noise suppression, and reduced maintenance of the track and track bed.

Grinding machines for maintaining railroad track rails in smooth, properly shaped condition are known. Such grinding machines generally comprise a plurality of rotatable grinding modules carried by a locomotive or the like, in close proximity to the rail head surfaces of a railroad track. The grinding modules include rotatable, abrasive grinding stones that can be lowered into a position flush with the rail surface to grind and restore the rail surface to a smooth, planar configuration.

Profiling of a rail can be accomplished through production rail grinding or specialized rail grinding. Generally, production rail grinding is utilized for long straight-aways and general rail lines. Production rail grinders are high-powered machines that can include up to 30 high powered motors and advanced control systems for precision metal removal along a length of railroad track. Production rail grinders have the ability to effectively perform preventative and corrective rail grinding and can extend the life of a rail, restore rail head profiles to optimize wheel and rail interaction, and precisely remove rail defects, plastic deformation and rolling contact fatigue. Generally, production rail grinding utilizes grinding modules, and in particular grinding stones, for completely profiling a railroad track rail. For example, production rail grinders can include 32-stone to 120-stone machine configurations. Examples of production rail grinding products include the RG 400 rail product, the C21/C44, and the RGI, all produced by Loram Maintenance of Way Inc. of Hamel, Minn.

Depending upon rail conditions or based on rail locations such as, for example, high stress rail areas, or areas of limited across points such as switches and switch yards, crossings, turns and curves, or any location where a transverse rail profile or top of rail surface conditions are different from the majority of the work area. In such locations a production rail grinder may not be able to satisfactorily address any defects at the rail location and instead, said rail location may require a specialized grinding machine.

Areas of high contact stresses and dynamic forces or areas having unique physical arrangements of the rail relative to its surrounding environment can present unique maintenance challenges requiring grinding flexibility. Railroads annually invest considerable resources to maintain and renew these areas across their rail networks. Specialized rail grinders generally include highly flexible grinding components allowing for a variety of physical approaches and positioning of the grinding elements to the rail. In this way, specialized rail grinders allow these specialty areas to receive the same attention as conventional mainline track. Specialized grinding machines can extend rail and specialty track component life, restore rail head profile to optimize wheel/rail interaction, remove rolling contact fatigue to mitigate defects, improve switch operation including reduced wheel climb, and reduce later forces to the rail. Representative, specialized rail grinder products include, for example, the RGS rail product and RGT Quick Deploy Rail Grinder, both produced by Loram Maintenance of Way Inc. of Hamel, Minn.

Specialized rail grinders can be used in tandem with production rail grinders during the rail grinding process such that an entire portion of a rail system can be reprofiled. Specialized grinding machines generally trail behind a production rail grinder and receive e communications from the production rail grinding machine as to rail locations that need the attention of the specialized rail grinder. An operator/rail servicer on the specialized rail grinder is generally required to assess location(s) requiring specialized grinding by stopping and observing an identified or specialty area or by physically getting out of the specialized rail grinder and inspecting an area that needs specialty attention. This observation and inspection can significantly slow the process of rail grinding while simultaneously exposing a rail servicer to potentially dangerous conditions adjacent to a rail assessment area. As will be appreciated, the specialized grinding capability of a rail grinding process is limited by the time it takes to physically and manually assess a potential specialty grinding event. As such, it would be beneficial to improve upon both the speed and safety of conventional rail grinding processes.

### SUMMARY

Systems and methods for autonomous detection of a rail event requiring specialized rail grinding and specialized rail grinding machines in accordance with the present invention include a first rail grinding machine and a second rail grinding machine operating in tandem. In particular, a first rail grinding machine and second rail grinding machine can include a memory, processor, and a sensor. A first rail grinding machine and a second rail grinding machine can also include at least one engine. In some aspects, an engine includes a patterning engine, an event engine, a transmission engine, a display engine, and/or an input/out engine. As will be understood by one of ordinary skill in the art, both the first and second rail grinding machine will each include conventional grinding components associated with commercially available grinders including a motive power source as well as grinding assemblies capable of positioning and rotating individual grinding elements for use in profiling rail.

Specifically, a first rail grinding machine can traverse a length of rail. In use, a first rail grinding machine can continually sense and capture rail conditions as it rolls along and traverses a length of rail and communicate the captured condition(s) to various onboard engines and processors. In some aspects, a first rail grinding machine can continually and simultaneously sense and capture any associated and/or information tangential to the same length of rail. According to an embodiment a first rail grinding machine can process captured rail conditions and detect rail defects or changes of track rail that require specialty rail grinding. A first rail grinding machine can further process the captured condition and any associated and/or information tangential to the captured rail condition including a captured or simulated image, and create an event. According to an embodiment of the present invention, an event corresponds to the location of capture, and further to conditions of the rail at said event location requiring specialty rail grinding.

In some aspects, systems and methods for autonomous detection of a rail event include building the event. In some aspects, building an event can include processing location information from the area requiring specialty grinding. Such information can include GPS data or data external to the event location. The event can be optionally compared against a stored list of conditions for further processing. A first rail grinding machine can process an event into a readable image and push the processed event to a second rail grinding machine for further processing.

In some aspects, a plurality of events can be captured, optionally stored, and processed for imaging and display. In some aspects, an event can correspond to a first location, a second location, or any other number of locations corresponding with a length of rail. Each location can include information that can be communicated to a first or second rail grinding machine. In some aspects, the information can be communicated to one or more additional grinding machines, a fixed location, or a site external from the rail site. In some aspects, such information can include starting location for grinding. In some aspects, such information can include a stop location for grinding.

According to an embodiment, a second rail grinding machine can receive a readable/viewable image of the event and display the image on a monitor or display screen. In some aspects the displayed event image can be a real or virtual representation of the captured event. In some aspects the displayed event image can include information associated with the event location such as exact coordinates, for example, GPS coordinates or mile markers, which are geographically tied to locations requiring specialty rail grinding. In this respect, an operator on the second rail grinding machine can view the displayed image and direct the second rail grinding machine to the exact event location identified for specialty rail grinding. In some aspects, the real or virtual depiction and representation allows an operator to view the event location without the need to physically observe and inspect a track rail. In some aspects, a virtual representation increases efficiency and safety of specialty rail grinding by allowing an operator to virtually interact, identify and inspect a section of rail in real time, without the need to stop the second rail grinding machine for a physical inspection of the event location.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram illustrating major internal components of an enhanced system for rail grinding according to an embodiment, to which event arrangements according to aspects of the invention can be applied.

FIG. 2 is a flowchart of a method for event detection and correction, according to an embodiment.

FIG. 3 is a flowchart of a method for event detection and correction, according to an embodiment.

FIG. 4 is a diagram illustrating a system arrangement according to aspects of the invention.

FIG. 5 is a diagram illustrating a production rail grinding machine and a specialized grinding machine with no executable specialty rail event present.

FIG. 6 is a diagram illustrating a production rail grinding machine and a specialized grinding machine with an executable specialty rail event present, to which a system depicted in FIG. 1 and/or method depicted in FIG. 3 or FIG. 4 can be applied.

FIG. 7 is a schematic depicting an executable specialty rail event and correction according to an embodiment, to which a system depicted in FIG. 1 and/or method depicted in FIG. 3 or FIG. 4 can be applied.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

The terms “a,” “an,” “the,” “at least one,” and “one or more” are used interchangeably. Thus, for example, a system that contains “a” sensor means that the system includes “one or more” sensors.

The term “autonomous” when used with respect to the systems and methods means existing or capable of existing independently such that a system or method can respond, react, or develop independently of the whole.

The term “capture” when used with respect to a track of rail means to record or preserve such that a track of rail is recorded in a permanent or semi-permanent file.

The term “detect” when used with respect to detect a portion of road intersecting a rail means to discover or determine the existence or presence of a variance on a portion of rail.

The term “sensing” when used with respect to sending a rail track means to detect automatically, especially in response to a stimulus.

Referring to the drawings, a system for enhanced rail grinding 100 broadly includes two rail grinding components, a first rail grinding machine 102 and a second rail grinding machine 116, according to an embodiment. First rail grinding machine 102 can be any production rail grinding product. More particularly, first rail grinding machine 102 may be the RG 400, the C21/C44, or the RGI, produced by Loram Maintenance of Way Inc. of Hamel, Minn. Second rail grinding machine 116 can be any specialized rail grinding product. More particularly, second rail grinding machine 116 may be the RGS product or RGT Quick Deploy Rail Grinder produced by Loram Maintenance of Way Inc. of Hamel, Minn. While the present invention is directed specifically to rail grinding, it can apply to similar rail profiling technologies including rail milling. In addition, the system 100 can accumulate and generate data that can be relevant to other methods of rail maintenance including ballast maintenance and replacement, rail replacement, tie replacement and the like.

First rail grinding machine 102 of system 100 generally comprises a processor 104, memory 106, sensor 108, patterning engine 110, event engine 112 and transmission engine 114. Second rail grinding machine 116 of system 100 generally comprises a processor 118, memory 120, display engine 122, and input/output engine 124. In some aspects, second rail grinding machine 116 can also comprise a sensor 108. System 100 includes various engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) 104, 118 of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engine, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of system 100, and the corresponding methods of configuring and operating the system 100, can be performed in cloud computing, client-server, or other networked environments, or any combination thereof. The components of the system can be located in a singular “cloud” or network, or spread among many clouds or networks. End-user knowledge of the physical location and configuration of components of the system is not required. For example, processor 104, memory 106, sensor 108, patterning engine 110, event engine 112, and transmission engine 114 can be combined as appropriate to share hardware resources, if desired. According to an embodiment, patterning engine 110, event engine 112, and transmission engine 114 can share a processor and memory, for example, processor 104 and memory 106, such that engines 110, 112, and 114 do not need their own separate instances of a processor and memory. According to an alternative embodiment, display engine 122 and input/output engine 124 can share a processor and memory, for example processor 118 and memory 120, such that engines 122 and 124 do not need their own separate instances of a processor and memory.

According to an embodiment of system 100, processor 104 and 118 of first rail grinding machine 102 and second rail grinding machine 116 can be any programmable device that accepts analog or digital data as an input, is configured to process the input according to instructions or algorithms, and provides results as outputs. In an embodiment, processor 104 and processor 118 can be a central processing unit (CPU) configured to carry out the instructions of a computer program. Processor 104 and processor 118 are therefore configured to perform at least basic arithmetical, logical, and input/output operations.

According to an embodiment of system 100, memory 106 of first rail grinding machine 102 and memory 120 of second rail grinding machine 116 can comprise volatile or non-volatile memory as required by the coupled processor 104 or 118 to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

According to an embodiment of system 100, sensor 108 of first rail grinding machine 102 generally comprises an apparatus for remotely sensing data related to an area of rail. In an embodiment, sensor 108 can comprise one or more sensors for capturing data proximate the path of travel of a rail grinder product. For example, a first rail grinding machine 102 can include an integrated imaging camera, thermal camera, or infrared camera. In an embodiment, the rail grinder can comprise two or more of the aforementioned remote cameras. In embodiments, system 100 can further comprise remote grinder-based sensors configured to capture similar visible, near infrared, or thermal imagery, such as a camera mounted on or under a moving grinding product mounted in a position such as on a pole, projection, or other apparatus providing relative height above the ground. In an alternative embodiment, satellite-based imagers can also be utilized. Embodiments are therefore able to utilize imagery from a myriad of imaging sources that might be available to users. In addition to image capture sensors, sensor 108 can further include conventional and emerging rail sensors for identifying rail and rail profile degradation and wear including LIDAR, ultrasonic, eddy current and electromagnetic field imaging sensors and the like.

In an embodiment, challenges inherent with physical event detection on track rails can be solved by systems and methods described herein. For example, conventional event detection for specialized rail grinding requires that a rail worker stop the rail car on which he is travelling, exit the rail car, and manually inspect a track rail section for a need of possible specialized grinding. The process of manual inspection for specialized rail grinding increases the time required to complete profiling and grinding of a tract of rail. Manual inspection of a rail also exposes the inspector to increased risks such as danger of being struck by a passing rail car or motor vehicle. Extreme weather and similar unexpected conditions can increase risks to an operator as well as increase the time required to complete the detection and inspection process associated with specialized rail grinding.

In embodiments, sensor 108 can capture images and data along a track of rail. According to an embodiment, a captured image or data point can be assigned an event identification (“event ID”). According to an embodiment, an event ID can include corresponding data points or information tangential to the captured image. In some aspects, a specific data point can include a location marker(s) such as geo-references, GPS data and/or longitude and latitude and mile markers. In some aspects, rail conditions external to the rail tract can also be captured. In some aspects, the information such as GPS coordinate and external rail data can be embedded with the captured image. For example, a data point that is pushed to patterning engine 110 will include an event ID corresponding to a plurality of information tangential to the captured image.

According to an embodiment of system 100, the image can be stored in memory 106 or pushed to patterning engine 110 for further processing. According to an embodiment, an image can be stored in memory 106 and used to create a database. In some aspects, the database can comprise one or more captured images. In some aspects, the database can comprises one or more captured images and corresponding event IDs. According to an embodiment, store images and/or store event IDs create a historical database that can be configured for future use. In some aspects, the historical database can be built continually. In such an embodiment, a historical database can be used to compare rail conditions for future sensing of the same rail track. In some aspects, the historical database can be used to refine pre-existing databases defining rail portion threshold. In some aspects, a historical database can be configured to continually refine parameters and tolerances for a rail track portion such that conditions from an area of rail track are continually updated. In some aspects, the historical database can be stored in memory 106. In some aspects the historical database can be pushed to an external location for further processing and/or analysis.

According to an embodiment of system 100, patterning engine 110 can be configured to receive and process information captured by sensor 108. According to an embodiment, patterning engine 110 generally can be configured to share processor 104 and memory 106. In some aspects, patterning engine 110 can detect a changed region or feature. In some aspects, patterning engine 110 can detect a change in a track of rail by comparing a captured image or data from a location against a threshold value. For instance, an engine of first rail grinding machine 102 can comprise a stored data set including threshold or historical values for areas of track rails. In some aspects, patterning engine 110 can compare received data and/or a received image against stored threshold or historical values and trigger an event when a value inside or outside a threshold is detected.

Rail areas typically have a lot of changes that are considered “normal” changes. Embodiments of first rail grinding machine 102 are configured to detect and transmit the changes rising to the level above “normal.” For example, according to an embodiment, patterning engine 110 can receive output data from sensor 108 and analyze the information against a stored internal database such as a historical database. In some aspects, patterning engine 110 can compare received captured data against internally programmed reference data set. In some aspects, images received from sensor 108 that matches a pre-programmed data set can be pushed to event engine 112.

In one aspect, the goal of patterning engine 110 is to present the change detection in relation to an internal database of or threshold or historical information to event engine 112. In one embodiment, machine learning is utilized to “learn” interesting changes. In other words, an algorithm can be trained to learn the changes users are typically interested in as well as the changes users might not typically be interested in.

According to an embodiment, system 100 further comprises event engine 112. According to an embodiment, event engine 112 is configured to receive an event from patterning engine 110. In some aspects, event engine 112 is configured to further process the event detected by patterning engine 110. In some aspects, event 112 is uniquely configured to process the detected event into an executable event. In some aspects, an executable event includes an event ID. In some aspects, event engine 112 can process an event ID into a readable and executable component for engines and/or processors of the first rail grinding machine 102 and/or the second rail grinding machine 116.

According to an embodiment, patterning engine 110 can push data of an executable event to event engine 112 and the executable event can be optionally stored in memory 106. According to an alternative embodiment, event engine 112 can receive an event from patterning engine 110 and push the event to transmission engine 114 for further processing.

According to an embodiment of system 100, transmission engine 114 is configured to receive and process the event output from event engine 112 and transmit the results to second rail grinding machine 116. According to an embodiment, transmission engine 114 can push information from event engine 112 to second rail grinding machine 116. In an alternative embodiment, transmission engine 114 can receive an executable event from event engine 112 and further process the executable against stored data in memory 106 before sending the executable event to second rail grinding machine 116.

According to an embodiment of system 100, display engine 122 is configured to receive and process the executable event data from transmission engine 114 and uniquely display the results. In some aspects, display engine 122 can deliver an executable event to input/output engine 124. In some aspects, display engine 122 can push the data to an outside source (not pictured) or alternatively store the data of the executable event at memory 106. According to an embodiment, a displayable event can be a visual representation, either real or virtual, of the event detected by sensor 108. For example, the displayable event can include the exact representation of the rail condition at the time sensor 108 captured the track rail. The displayable event can also incorporate data from the event ID, including longitude and latitude of the event, and/or external data from the location of the executable event. Such external data can include conditions of an area directly adjacent to a track rail, for example, the presence of encumbrances such as rail crossings.

According to an embodiment, the goal of display engine 122 is to process received data into a viewable and/or interactive displayable representation of the executable event for a user interface. In some aspects, the representation of the event can be two dimensional. In an alternative aspect, the representation of the event can be three-dimensional.

In an alternative embodiment, display engine 122 can uniquely display a changed region or feature on an interactive interface or PID, monitor, screen, tablet, or the like. In some aspects, control tools can be utilized to view and/or interact with the displayable image. In some aspects, a knob and slider may be utilized. For example, graphical knobs can control the duration of a viewing period and a degree of change can be presented. Slider bars can control the relative proportions of views and the kinds of change an operator wishes to be displayed can also be presented. According to an embodiment, user parameters can adjust the severity of the displayable image and the kinds of change being displayed. For instance, the underlying dataset (source imagery) of the executable event and event ID retains pixels of a certain dimension according to the composite image, but the user interface to view these pixels at varying levels can thus be controlled.

According to an embodiment, system 100 can further include wireless communication circuitry, which can take the form of a mobile telephone radio (CMA, GSM, Iridium, or the like), Wi-Fi, Bluetooth, or any other such communications circuitry, coupled to an antenna. Using said wireless communication circuitry, it will be understood that processor 104 can be interfaced with processor 118. It will also be understood that processor 104 and 118 can be interfaced with a portable information device (PID) or display. A PID can be a smartphone, PDA, UMPC, MID, tablet or any other small lightweight computing and communications device. According to one aspect, a PID can be configured to be interfaced with a display screen and a user input device, such as a keyboard or mouse. In some aspects, a PID can be interfaced with a touchscreen display in which an event is displayed and user input devices are integrated. According to an embodiment, a display can be a device larger than a PID, such as a large tablet or screen such as a monitor or the like, and may be portable. According to an embodiment, when used with system 100, PID and displays enable a user to view a rail section that can be profiled with a specialized grinder.

According to an embodiment, system 100 can also comprise a power supply with an on-board energy source in the form of a battery. In some aspects a PID interfaced with a processor 104 or 118 can include an on-board energy source in the form of a battery, enabling a portable and mobile operation. In some aspects, a monitor or portable display can include an on-board energy source in the form of a battery, enabling a portable and mobile operation. Power supply provides appropriate power to all of the components of system 100 and includes circuitry to enable external power to be supplied to operate a PID or display and to charge and energy source. It will be further understood that first rail grinding machine 102 and second rail grinding machine 116 can each incorporate conventional generator and inverter technology to provide power sources to the various onboard components.

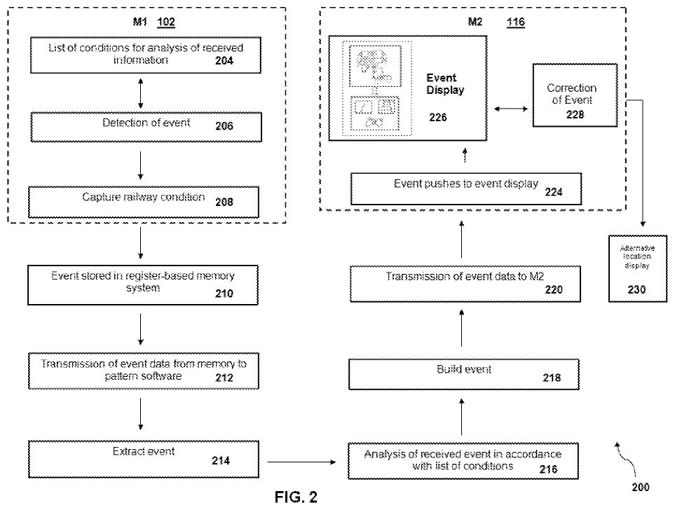

Referring to FIG. 2, a flow chart of method 200 for enhanced rail grinding is depicted, according to an embodiment. According to an embodiment of the present invention, method 200 can be implemented by system 100. Method 200 describes the basic steps for enhanced event detection and correction of an event according to aspects and embodiments of the present invention.

According to an embodiment, method 200 can generally comprise a first rail grinding machine 102. According to an embodiment, first rail grinding machine 102 can comprise a stored list of conditions for analyzing and comparing received information 204. According to an embodiment, a list of conditions for analysis can be stored in memory 106 of first rail grinding machine 102. In some aspects, a list of conditions can comprise sensor parameters defining an event threshold for a rail area or track rail. In some aspects, a list of conditions can comprise threshold(s) that further define sensor 108 conditions. In some aspects defined sensor 108 conditions can signal or indicate an area of rail above and/or below normal or historical conditions defined for a particular tract of rail. In some aspects an expected condition, is defined by a threshold and corresponding sensor 108 parameters. In some aspects, a sensed track of rail that is not outside or inside a set of defined parameters and/or threshold does not trigger an event. In some aspects, a sensed track of rail that is outside or inside a set of defined parameters and/or threshold can trigger event detection.

According to an embodiment, a sensor 108 can detect and capture a change in rail condition 206 over a particular rail area. According to an alternative embodiment, a second sensor can detect 206 and capture 208 additional rail conditions for the same rail area. According to an embodiment, first rail grinding machine 102 can command sensor 108 to sense 206 and capture 208 an event at a first time and/or location and again at a second time and/or location. For example, first rail grinding machine 102 can sense an event at a first location and send the data to processor 104 or an engine(s) of first rail grinding machine 102. A first detected event is assigned an event ID that corresponds to the first location. Sensor 108 can continue to sense 206 and capture rail data 208 along a length of rail until captured data 208 no longer rises above or below a threshold. For instance, an event can be created at a last location of threshold intolerance. In some aspects, the event can be assigned an event ID and the event can be sent to processor 104 or an engine of the first rail grinding machine 102.

Controlled periodicity of rail capture 208 defined by method 200 and/or system 100 can allow an embodiment to detect transient issue more effectively than traditional solutions. In some aspects, controlled periodicity corresponds to track rail sensing at a higher frequency. Higher frequency sampling along a track of rail and subsequent ability to detect transient issue are two features that set the invention apart from traditional rail detection.

According to an alternative embodiment, sensor 108 can provide additional specific details of a rail condition and/or rail location such as longitude and latitude, surrounding rail area condition, and conditions rising even slightly above or below a defined sensor 108 parameter or threshold. The comprehensive analysis of a rail and detected event 206 further sets the invention apart from traditional rail condition detection.

For example, not all areas of a rail have the same change detection and event detection priority. Consider the following example of an event heavy track rail. In some aspects, an event heavy track rail can be a particular area or section of heavily traveled or intersected rail way, such as rails intersecting metropolitan areas with increased streets crossing, bridges, and/or turns. Event heavy track rails can have a higher importance than a straight away rail way that historically requires minimal or no specialized grinding equipment. In some aspects, efficiency of rail grinding can be improved with increased detection on heavily traveled railways or railways that have an increase in events such as road intersections or curves, both of which can affect the requirements of specialty grinding.

According to an embodiment, detection 206 and capture 208 of an event heavy railway can be generated at higher frequency than a straight track rail. For example, sensor 108 can be programmed to capture all rails being traveled by first rail grinding machine 102 at a specified frequency. Sensor 108 can be programmed to sense 206 and capture track rail data 208 at locations presenting specialized rail grinding needs with a frequency that is higher than that of a straight away railway.

In an embodiment, controlled periodicity can be combined with a location adjustment, such as GPS adjustment, to favor high priority areas. For example, first rail grinding machine 102 can be programmed for sensing 206 and capture 208 at particular latitudes and longitudes, GPS coordinates or mile markers corresponding to a rail area that has an increased amount of road crossings. In an alternative example, first rail grinding machine 102 can be programmed so sensing 206 and capture 208 at a particular latitude and longitude corresponding with mountainous terrain or an area with a higher frequency of curves or bridges. Capturing 208 this type and frequency of rail information allows for the ability to find events 206 and/or locations that need specialized grinding at an increased frequency.

Fundamentally, at 102, sections of the same rail can be captured 208 at different times. According to an embodiment, sensing and detection 206 and capture 208 of railway can be conducted at any light exposure. According to an embodiment, multiple images at a first time and multiple images at a second time for the same rail section are captured 208. In some aspects, a preferred sensing frequency is every five feet. In some aspects, a maximum imaging frequency is every one foot, and a minimum imaging frequency is every 25 feet.

According to embodiments of method 200, the method further comprises storing the event in a register-based memory system 210. According to an embodiment, memory 106 can store the detected event for building a set of stored event conditions. According to an alternative embodiment, memory 106 can store the detected event for a pre-set amount of time that ranges from seconds to an infinite amount of time.

Method 200 further comprises storing an event in a register-based memory system 210. In some aspects, memory 106 can receive a captured event 208 and store the event 210 for further processing. In some aspects, a stored event 210 can be transmitted from memory 106 to patterning software 212 of patterning engine 110. According to an embodiment of method 200, patterning engine 110 can be configured to register, align, and compile a first set of sensory information received from memory 106 with the information of captured event 208 to generate a composite image merging historical and real-time information. Patterning engine 110 can be further configured to register, align, and compile a second set of sensory information received from memory 106, into a composite image.

Method 200 further comprises extracting an event 214. According to an embodiment, an extracted event can correspond with a section of rail that has been identified as potentially needing specialized rail grinding.

Method 200 further comprises analyzing an event in accordance with the list of conditions 216. According to an embodiment, analysis of a received event in accordance with a list of conditions 216 comprises using a list of conditions that is continually built, updated and refined. Referring back to the previous example of an event heavy railway, according to an embodiment, first rail grinding machine 102 can be configured to continually sense 206, capture 208 and store captured data from event heavy railways. In one aspect, an increased frequency of sensing 206 can increase captured images from a track rail 208 and the captured data can be used to build an updated database of rail conditions. According to an embodiment, data from event heavy locations can be stored in a data base used to compare captured rail conditions against the list of conditions 204 stored in memory 106 from previous passes. For example, at a rail location such as a metropolitan city, that comprises rails with high use, there is an increase in average of the wear and tear of a track rail compared to other less traveled rail ways. A stored data base of rail conditions can allow an operator to assess average degradation of a rail and need for specialty grinding. Analysis of rail wear from comparing rail conditions in the stored data base can alert a rail company to areas of rail that may need increased maintenance such as specialty grinding or rail replacement. Accordingly, event detection can be increasingly improved as additional rail conditions are stored in memory 106. Thus, in some aspects, the list of conditions for analysis of received information can be continually built and stored for further analysis. Therefore, in some aspects, a received event can be analyzed in accordance with an evolving and continually refined list of conditions that is particular to a specific area of railway.

According to an alternative embodiment of method 200, analyzing a received event in accordance with a list of conditions 216 comprises using the same list of conditions as those at step 204 for analysis of received information. In an alternative embodiment, a separate list of conditions can be used. In some aspects, event engine 112 can retrieve a list of conditions and process an extracted event into a form in which change detection can be conducted. According to method 200, event engine 112 can compare an extracted event against a list of conditions. According to an embodiment, a list of conditions is a set a parameters that indicates a section or portion of rail that defines a need specialty rail grinding. In some aspects, an extracted event can be compared against a list of conditions. In some aspects, a list of conditions can further include information associated with an extracted event and event ID.

According to an embodiment, method 200 further comprises building event 218. In some aspects when an extracted event matches a set of parameters from a list of conditions, an event is built 218. In some aspects, building an event 218 includes associating an extracted event, the corresponding event ID, and any other additional information into a singular executable event. In some aspects processor 104, patterning engine 110, and/or event engine 112 can process raw imagery of a captured railway condition and any associated, additional information, into an event for viewing on a display or PID. For example, processor 104, sensor 108, and/or patterning engine 110, via a wired or wireless connection, can upload an event that has been analyzed in accordance with a list of conditions to memory 106.

According to an embodiment, method 200 further comprises transmission of event data to second rail grinding machine 116. According to an embodiment, transmission engine 114 can retrieve stored event information and process it into a form for transmission to second rail grinding machine 116. In some aspects, first rail grinding machine 102 can be interfaced with second rail grinding machine 116 with wireless communication circuitry to transmit the event from first rail grinding machine 102 to second rail grinding machine 116. In some aspects processor 118 can process a received event and push the event to memory 120. In an alternative aspect, processor 118 can process the received event and push the event to event display 226.

According to an embodiment, method 200 can further comprise displaying an event 226 at second rail grinding machine 116. According to an embodiment, display engine 122 can process a received event and generate an image representative of the event. For example, display engine 122 can generate an interactive overlay that highlights rail sections indicating a need for specialty rail grinding. In some aspects, display engine 122 can retrieve and display a historical image from memory 120. In some aspects, display engine 122 can generate an image that is a real time image of a rail section corresponding to a detected event. In some other aspects, display engine 122 can generate a virtual image that is essentially a simulated but identical representation of an event.

According to an embodiment, the image can be displayed on a monitor, display screen, or PID at a location in second rail grinding machine 116. In some aspects, the image can be displayed on an interactive display screen. In some aspects, the image can be a two-dimensional image. In some other aspects, the image can be a three-dimensional image.

According to an embodiment of method 200, a monitor, display screen, or interactive screen can be interfaced with a mobile device such as PID, tablet, or in some instances a virtual reality (VR), augmented reality (AR) or mixed reality (blending of the physical world with the digital world) device. In some aspects, a mobile device, such as a VR, AR or mixed reality device, can allow a user to interact with the event display. For example, display screen can project an interactive image of an event 226 at a location in second rail grinding machine 116. In some aspects, an operator at a location in second rail grinding machine 116 can interact with the display image through an interfaced PID, tablet, VR, AR or mixed reality device. According to an embodiment, a user can view the image in real time, or the image can be a stored image from memory 106.

According to an embodiment, method 200 can further comprise correction of an event 228. According to an embodiment, an operator can interact with a displayed event 226 through an interface. In some aspects the interface is an interactive interface such as a PID or VR, AR or mixed reality device. For example, an operator can display an image and visually see the section of rail that triggered an executable event at the event location. In some aspects, an operator can interact with a device that is interfaced with the display and direct a specialized rail grinder to an event location. In some aspects, a specialized grinder is second rail grinding machine 116.

In some aspects, the display can be located at first rail grinding machine 102. In an alternative aspect, the display can be at second rail grinding machine 116. According to an embodiment, an operator can use a VR, AR or mixed reality device at first rail grinding machine 102 and direct a separate rail grinder to the displayed location. In some aspects, the separate rail grinder is second grinding machine 116. In some aspects an operator can use a VR, AR or mixed reality device at second rail grinding machine 116 such that the operator is controlling the second rail grinding machine 116 from within. In another aspect an operator can control a specialized rail grinder from an alternative display location 230. In some aspects an alternative display location 230 can be a location that does not include second rail grinding machine 116, such as stationary base of operations, for instance an office.

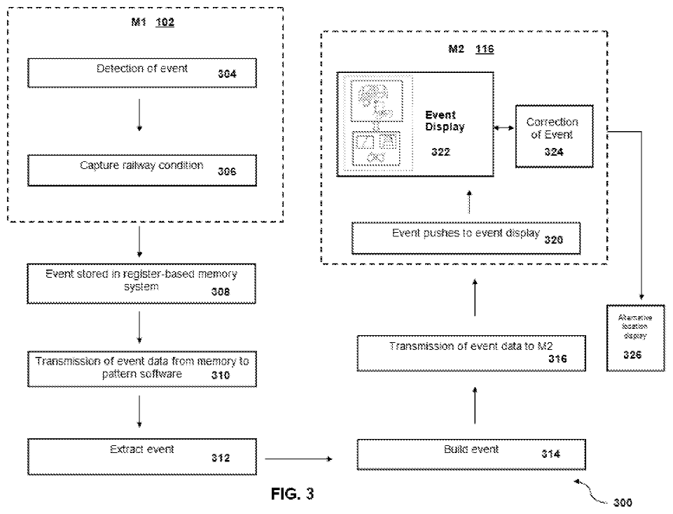

Referring now to FIG. 3, a flow chart of method 300 for enhanced rail grinding is depicted, according to an alternative embodiment. Method 300 can be implemented by system 100, for example. According to an embodiment of the present invention, method 300 can be implemented by system 100. Method 300 describes the basic for enhanced event detection and correction of an event According to aspects and embodiments of the present invention.

According to embodiments, method 300 can generally comprise a first rail grinding machine 102. According to an embodiment, first rail grinding machine 102 can detect an event 304. In some aspects, a sensor 108 can detect and capture a change in rail condition 304 over a particular rail area. According to an alternative embodiment, a second sensor can detect 304 and capture 306 additional rail conditions for the same rail area. Embodiments of first rail grinding machine 102 can command sensor 108 to sense 304 and capture 306 an event at a first time and/or location and again at a second time and/or location. For example, first rail grinding machine 102 can sense an event at a first location and send the data to processor 104 or an engine(s) of first rail grinding machine 102. A first detected event is assigned an event ID that corresponds to the first location. Sensor 108 can continue to sense 304 and capture rail data 306 along a length of rail. In some aspects, an event can be assigned an event ID and the event can be sent to processor 104 or an engine of the first rail grinding machine 102.

Controlled periodicity of rail capture 306 defined by method 300 and/or system 100 can allow an embodiment to detect transient issue more effectively than traditional solutions. In some aspects, controlled periodicity corresponds to track rail sensing at a higher frequency. Higher frequency sampling along a track of rail and subsequent ability to detect transient issue are two features that set the invention apart from traditional rail detection.

According to an alternative embodiment, sensor 108 can provide additional specific details of a rail condition and/or rail location such as longitude and latitude, GPS coordinates, mile markers, surrounding rail area condition, and conditions rising even slightly above or below a normal condition. The comprehensive analysis of a rail and detected event 304 further sets the invention apart from traditional rail condition detection.

For example, not all areas of a rail have the same change detection and event detection priority. Consider the following example of an event heavy track rail. In some aspects, an event heavy track rail can be a particular area or section of heavily traveled or intersected rail way, such as rails intersecting metropolitan areas with increased streets crossing, bridges, and/or turns. Event heavy track rails can have a higher importance than a straight away rail way that requires minimal or no specialized grinding equipment. It is very important to detect any issues or events 304 on a railway that is heavily traveled or that has many events such as road intersections or curves, which can affect the requirements of specialty grinding.

According to an embodiment, detection 304 and capture 306 of an event heavy railway can be generated at higher frequency than a straight track rail. For example, sensor 108 can be programmed to capture all rails being traveled by first rail grinding machine 102 at a specified frequency. Sensor 108 can be programmed to sense 304 and capture track rail data 306 at locations presenting specialized rail grinding needs with a frequency that is higher than that of a straight away railway.

In an embodiment, controlled periodicity can be combined with a location adjustment, such as GPS adjustment, to favor high priority areas. For example, first rail grinding machine 102 can be programmed for sensing 304 and capture 306 at particular latitudes and longitudes, GOS coordinates or mile markers corresponding to a rail area that has an increased amount of road crossings. In an alternative example, first rail grinding machine 102 can be programmed so sensing 304 and capture 306 at a particular latitude and longitude corresponding with mountainous terrain or an area with a higher frequency of curves or bridges. Capturing 306 this type and frequency of rail information allows for the ability to find events 304 and/or locations that need specialized grinding at an increased frequency.

Fundamentally, at 102, sections of the same rail can be captured 306 at different times. According to an embodiment, sensing and detection 304 and capture 306 of railway can be conducted at any light exposure. According to an embodiment, multiple images at a first time and multiple images at a second time for the same rail section are captured 306. In some aspects, a preferred sensing frequency is every five feet. In some aspects, a maximum imaging frequency is every one foot, and a minimum imaging frequency is every 25 feet.

According to embodiments of method 300, the method further comprises storing the event in a register-based memory system 308. According to an embodiment, memory 106 can store the detected event for building a set of stored event conditions. According to an alternative embodiment, memory 106 can store the detected event for a pre-set amount of time that ranges from seconds to an infinite amount of time.

Method 300 further comprises storing an event in a register-based memory system 308. In some aspects, memory 106 can receive a captured event 306 and store the event 308 for further processing. In some aspects, a stored event 308 can be transmitted from memory 106 to patterning software 310 of patterning engine 110. According to an embodiment of method 300, patterning engine 110 can be configured to register, align, and compile a first set of sensory information received from memory 106 with the information or captured event 306 to generate a composite image merging historical and real-time information. Patterning engine 110 can be further configured to register, align, and compile a second set of sensory information received from memory 106, into a composite image.

Method 300 further comprises extracting an event 312. According to an embodiment, an extracted event can correspond with a section of rail that has been identified as potentially needing specialized rail grinding.

According to an embodiment, method 300 further comprises building event 314. In some aspects, building an event 314 includes associating an extracted event, the corresponding event ID, and any other additional information into a singular executable event. In some aspects processor 104, patterning engine 110, and/or event engine 112 can process raw imagery of a captured railway condition and any associated, additional information, into an event for viewing on a display or PID. For example, processor 104, sensor 108, and/or patterning engine 110, via a wired or wireless connection, can upload an event that has been analyzed in accordance with a list of conditions to memory 106.

According to an embodiment, method 300 further comprises transmission of event data to second rail grinding machine 116. According to an embodiment, transmission engine 114 can retrieve stored event information and process it into a form for transmission to second rail grinding machine 116. In some aspects, first rail grinding machine 102 can be interfaced with second rail grinding machine 116 with wireless communication circuitry to transmit the event from first rail grinding machine 102 to second rail grinding machine 116. In some aspects processor 118 can process a received event and push the event to memory 120. In an alternative aspect, processor 118 can process the received event and push the event to event display 322.

According to an embodiment, method 300 can further comprise displaying an event 322 at second rail grinding machine 116. According to an embodiment, display engine 122 can process a received event and generate an image representative of the event. For example, display engine 122 can generate an interactive overlay that highlights rail sections indicating a need for specialty rail grinding. In some aspects, display engine 122 can retrieve and display a historical image from memory 120. In some aspects, display engine 122 can generate an image that is a real time image of a rail section corresponding to a detected event. In some other aspects, display engine 122 can generate a virtual image that is essentially a simulated but identical representation of an event.

According to an embodiment, the image can be displayed on a monitor, display screen, or PID at a location in second rail grinding machine 116. In some aspects, the image can be displayed on an interactive display screen. In some aspects the image can be a two-dimensional image. In some other aspects the image can be a three-dimensional image.

According to an embodiment of method 300, a monitor, display screen, or interactive screen can be interfaced with a mobile device such as PID, tablet, or in some instances a virtual reality (VR), augment reality (AR) or mixed reality device. In some aspects a mobile device, such as a VR, AR or mixed reality device, can allow a user to interact with the event display. For example, display screen can project an interactive image of an event 322 at a location in second rail grinding machine 116. In some aspects, an operator at a location at second rail grinding machine 116 can interact with the display image through an interfaced PID, tablet or VR, AR or mixed reality device. According to an embodiment, a user can view the image in real time, or the image can be a stored image from memory 106.

According to an embodiment, method 300 can further comprises correction of an event 324. According to an embodiment, an operator can interact with a displayed event 322 through an interface. In some aspects the interface is an interactive interface such as a PID or VR, AR or mixed reality device. For example, an operator can display an image and visually see the section of rail that triggered an executable event at the event location. In some aspects, an operator can interact with a device that is interfaced with the display and direct a specialized rail grinder to an event location. In some aspects, a specialized grinder is rail profiling machine 116.

In some aspects, the display can be located at first rail grinding machine 102. In an alternative aspect, the display can be at second rail grinding machine 116. According to an embodiment, an operator can use a VR, AR or mixed reality device at first rail grinding machine 102 and direct a separate rail grinder to the displayed location. In some aspects, the separate rail grinder is second grinding machine 116. In some aspects an operator can use a VR, AR or mixed reality device at second rail grinding machine 116 such that the operator is controlling the second rail grinding machine 116 from within. In another aspect an operator can control a specialized rail grinder from an alternative display location 322. In some aspects an alternative display location 322 can be a location that does not include second rail grinding machine 116, such as stationary base of operations, for instance an office.

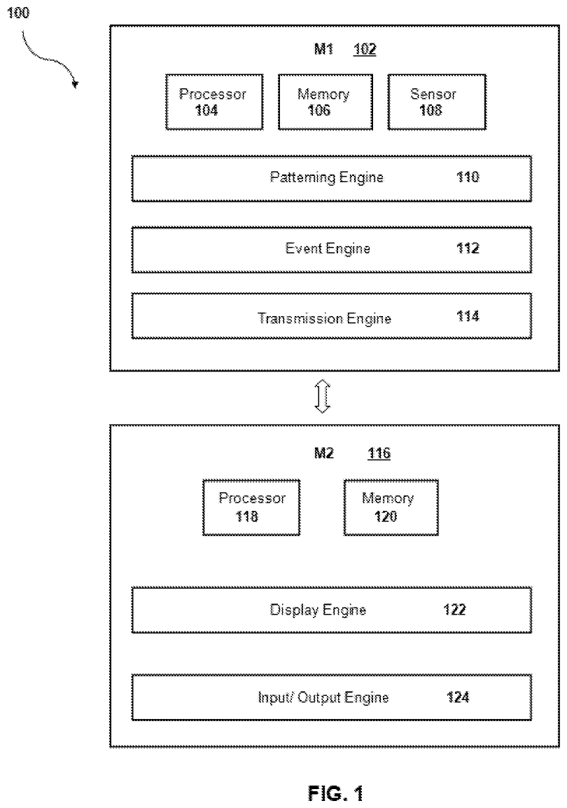

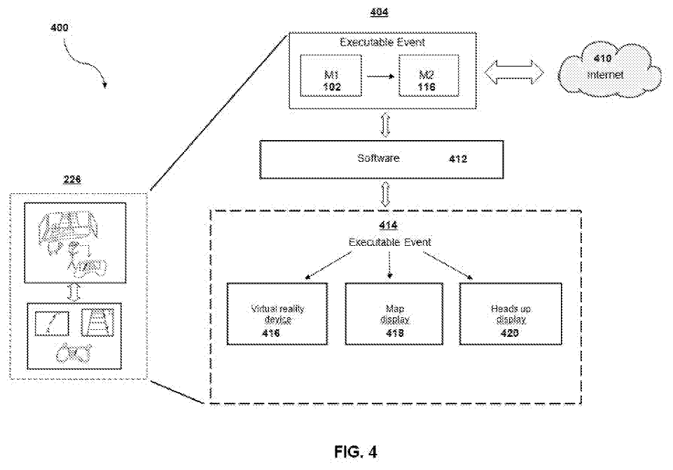

Referring now to FIG. 4, a system arrangement 400 according to an embodiment in which a user or operator can correct an event using an interactive interface. The arrangement utilizes the components of an enhanced system 100 and methods for rail grinding 100 and 200 as described above, with reference to FIGS. 1, 2, and 3.

According to arrangement 400, an executable event is created by a system comprising a first rail grinding machine 102 and second rail grinding machine 116. According to an embodiment, first rail grinding machine 102 can communicate an executable event to second rail grinding machine 116. In some aspects an executable event is pushed to the internet 410 or software 412 for further processing. Software 412 communicates the executable event 414 to a virtual reality device 416, a map display 418, and/or a heads up display 420.

According to arrangement 400, components of the described system 100 and methods 200 and 300 can capture a section of rail and present the image to an operator at location 402. The location can be at a rail grinding machine, or at an alternative location. In some aspects the location is first rail grinding machine 102. In some aspects, the location is second rail grinding machine 116. In an alternative aspect, the location is a fixed location such as a brick and mortar office building.

According to an embodiment of arrangement 400, a captured image can be displayed to a user at 402 through a virtual reality device 416, a map display 418, and/or a heads up display 420. In some aspects the image can be two-dimensional. In some aspect the image is three-dimensional. At 402, the displayed image is identical to a captured event and an operator or user can optionally interact with the image according to operator preference. Components of arrangement 400 producing displayed image 402 can be in continually communication to provide updates to an operator.

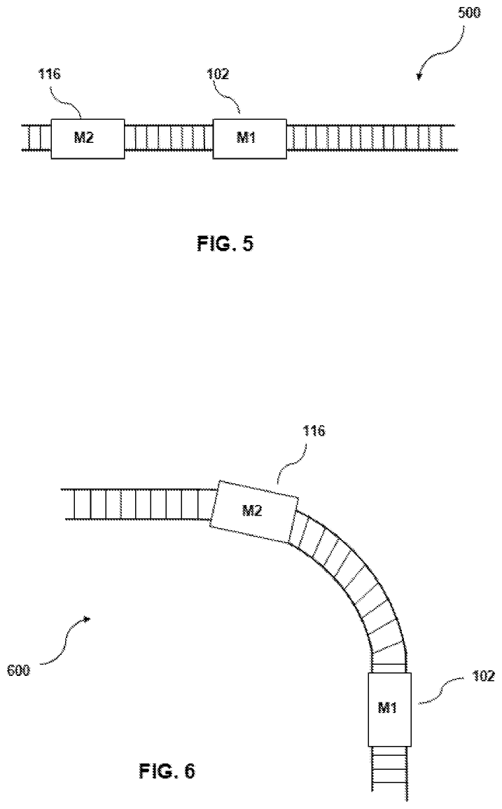

In use, system 100, methods 200 and 300, and arrangement 400 can be used to detect and correct a track rail requiring specialty rail grinding. FIG. 5 illustrates a tract of rail with no executable event present 500. During normal use and operation, a first rail grinding machine 102 and a second rail grinding machine 116, travel a length of rail. As depicted in FIG. 5, a length of rail traveled by profiling machines 116 and 102 are often straight and/or present no need or requirement for specialty rail grinding.

A first rail grinding machine 102 typically operates at a grinding speed of up to 20 mph, and generally moves and grinds in a single direction as it travels the length of rail. A second rail grinding machine 116 typically grinds intermittently at only indicated locations. When the second rail grinding machine 116 is not grinding, the grinding assembly are generally in a raised, non-grinding positions and the second rail grinding machine can move along the length of rail at a transit speed that is faster than the grinding speed of the first rail grinding machine 102. Generally, the second rail grinding machine 116 travels at a location behind the first grail grinding machine 102 that can be anywhere from about zero to five miles behind the first rail grinding machine 102. The second rail grinding machine 116 is typically a specialized grinder that when grinding rail at locations requiring specialized grinding, will traverse forward and back over these locations until the specialized grinding is completed at that location. Typically, the back and forth specialized grinding results in a specialized grinding speed that is reduced as compared to the first rail grinding machine 102. In addition, with conventional specialized grinding machines, an operator must stop the specialty rail grinder, get out and inspect the area and potential grinding needs prior to starting specialized grinding at that location. The processes of stopping, inspecting and then initiating specialty grinding adds to the length of time and inefficiency surrounding conventional rail grinding.

In comparison, FIG. 6 depicts a tract of rail with a bend or curve 600. Typically, a curve or bend in a rail tract requires specialty rail grinding. According to the embodiment depicted in FIG. 6, a first rail grinding machine 102 can travel along a length of rail. According to the systems and methods as previously described, and as depicted in FIGS. 1-4, a first rail grinding machine 102 will indicate to a second rail grinding machine 116 the location and need for specialty grinding.

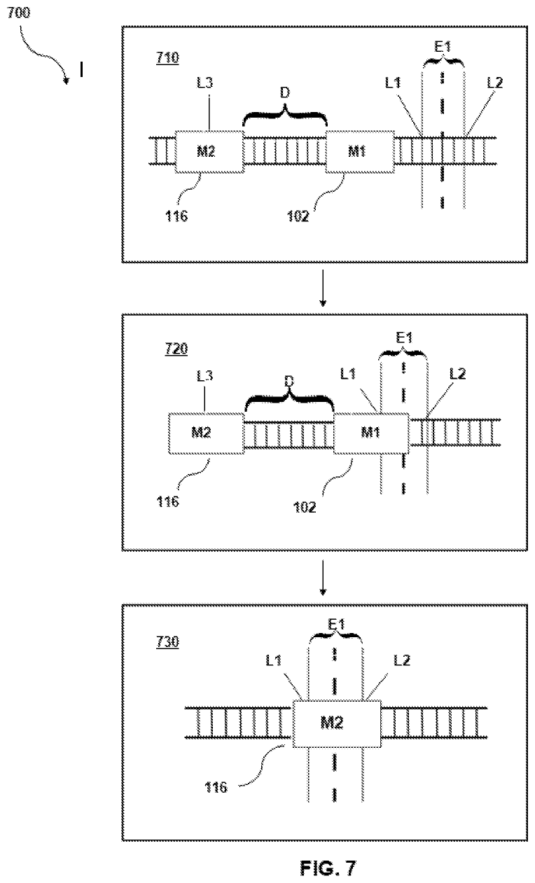

Turning now to FIG. 7, FIG. 7 illustrates an example of a rail tract with an executable event 700. According to an embodiment, the described system 100, method 200 or 300, and arrangement 400 can be utilized to detect and correct executable event 700. According to systems and methods as described herein, a rail tract with an executable event 700 can utilize a first rail grinding machine and a second rail grinding machine. In some aspects, the first rail grinding machine is first rail grinding machine 102. In some aspects, the second rail grinding machine is second rail grinding machine 116. In some aspects, the first rail grinding machine 102 is a production rail grinder. In some aspects, the second rail grinding machine 116 is a specialized rail grinder.

FIG. 7 depicts one potential embodiment of an executable event 700. According to the embodiment illustrated by FIG. 7, the executable event is a portion of road that intersects and traverses across a portion of railway. According to an alternative embodiment, an executable event according to FIG. 7 can be any event as previously described, such as a curve or switch crossing. According to an embodiment, a first event location is indicated by L1 and a second event location is indicated by L2. The length traversing from L1 to L2 is the event location (“E1”).

According to an embodiment according to the present invention, in use, as first rail grinding machine 102 traverses a length of rail 720 at a distance D, ahead of a second rail grinding machine 116. According to embodiments, the distance D between first rail grinding machine 102 and second rail grinding machine 116 can be from about 100 yards to more than 5 miles. According to an embodiment, as first rail grinding machine 102 traverses a length of rail it continually senses the track of rail according to method 200 or 300. As first rail grinding machine 102 traverses a length of rail, it can detect a portion of road intersecting a section of the rail.

According to systems and methods described herein, first rail grinding machine 102 can trigger an event at a first event location L1. As described in more detail above, a triggered event can initiate an event sequence that can optionally include associating GPS information and additional rail conditions surrounding the first event and event location L1 to the event. According to an embodiment of the present invention as illustrated in FIGS. 1-4, first rail grinding machine 102 can then associate the first location L1 with a displayable image in which an operator or user can interact.

According to an embodiment of FIG. 7, an event is continually triggered by first rail grinding machine 102 along a track of rail so long as information received by sensor 108 is outside or inside a marked threshold value according to system 100 and method 200 or 300. In some aspects, when information received from sensor 108 of first rail grinding machine 102 is not outside or inside a threshold value, a second event is triggered according to system 100 and method 200 or 300.

According to an embodiment, first rail grinding machine 102 can assign a second event location L2 to last event detection location. According to an embodiment, the second event location L2 can be constructed in the same manner as the first event location L1. According to an embodiment, the distance between a first event location L1 and second event location L2 is defined as event, E1.

In some aspects, additional information associated with the first event location L1 and second event location L2 can be processed, communicated and displayed to an interactive interface and operator.

According to use of embodiments of the present invention and as depicted in schematic 730, an operator can interact with the received information and command second rail grinding machine 116 to travel to event E1. In some aspects, information from L1 and L2 is communicated from first rail grinding machine 102 to second rail grinding machine 116. In some aspects, second rail grinding machine 116 is at a third location L3, some distance D, from the first rail grinding machine 102.

In some aspects, information associated with L1 indicates a starting location for specialized rail grinding to the second rail grinding machine 116. In some aspects, information associated with L2 indicates a stopping location for specialty rail grinding to the second rail grinding machine 116.

According to aspects of the present invention, a second rail grinding machine 116 at a third location L3, can traverse distance D at pace faster than typical specialized rail grinders. According to embodiments of the present invention, because a second rail grinding machine 116 has the exact location for beginning and ending specialized grinding on area of track rail, the second rail grinding machine 116 can forgo slow and methodical approaches to traversing a length of rail that is generally associated with typical specialized rail grinding processes.

According to an embodiment, a second rail grinding machine 116 can be commanded to manually drive to the first location L1. In some aspects, the second rail grinding machine can be commanded to autonomously drive to the first location L1. According to an embodiment, second rail grinding machine 116 will travel distance D to the first location L1 to correct the triggered event. In some aspects, second rail grinding machine 116 can correct the triggered event by profiling and grinding the known specialized rail grinding area of rail as it traverses the length of rail associated with the event E1. According to an embodiment, when second rail grinding machine 116 reaches the second location L2 a notification is triggered and communicated to the second rail grinding machine 116 to stop rail profiling and grinding. In some aspects, rail grinding and profiling performed by the second rail grinding machine 116 can be stopped manually. In some aspects, rail grinding and profiling performed by the second rail grinding machine 116 can be stopped autonomously.

According to an embodiment, upon completion of rail profiling and grinding of event E1, the second rail grinding machine 116 can communicate the first rail grinding machine 102 that the event has been corrected. In some aspects, second rail grinding machine 116 can continually and simultaneously sense and capture the rail condition of E1 as the length of rail undergoes specialized rail grinding. In some aspects, second rail profiling machine 116 can capture a completed portion of rail after specialized grinding has been performed. In some aspects, this information can be stored in memory 106. In some aspects, this information can be used to build a historical data base for use. In an alternative aspect, this information can be sent to an outside location for further processing and analysis. For instance, the information can be sent to an outside source for monitoring quality assurance.

According to an embodiment, the systems and methods described herein can be used continually along tracts of rails for an infinite period of time.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method for enhanced rail grinding, the method comprising:
grinding a track rail with a first grinding machine,
identifying a portion of the track rail that requires the attention of a specialized second grinding machine;
creating an event associated with the portion of the track requiring specialized grinding;
transmitting the event to an operator of the specialized second grinder;
displaying the event to the operator; and
conducting specialized grinding at the portion of the track rail with the specialized second grinding machine.

2. The method of claim 1, wherein the step of grinding the track rail with the first grinding machine comprises:
traversing the track rail in only a single direction with the first grinding machine.

3. The method of claim 2, wherein the step of conducing specialized grinding with the specialized second grinding machine comprises:
performing multiple grinding passes over the portion of the track rail with the specialized second grinding machine.

4. The method of claim 1, wherein the operator is located on the specialized second grinding machine.

5. The method of claim 1, wherein the step of displaying the event to the operator comprises:
displaying an image of the portion of the track rail requiring specialized grinding prior to the specialized second grinder arriving at the portion of the track rail requiring specialized grinding.

6. The method of claim 6, wherein the image is displayed on one or more of an interfaced PID, a computer monitor, a virtual reality device, an augmented reality device and a mixed reality device.

7. The method of claim 6, wherein the step of conducting specialized grinding at the portion of the track rail with the specialized second grinder is performed without the specialized second grinding stopping to inspect the portion of the track rail that requires specialized grinding.

8. The method of claim 1, wherein identifying a portion of the track rail that requires the attention of a specialized second grinding machine, comprises:
comparing a current condition of the track rail to a threshold condition to identify when the current condition is outside of an expected track parameter.

9. The method of claim 8, wherein the expected track parameter is based on a normal condition of the track rail or a historical condition of the track rail.

10. The method of claim 8, wherein the step of comparing the current condition of the track rail comprises:
employing one or more sensor assemblies to identify the current condition of the track rail.

11. The method of claim 10, wherein the one or more sensor assemblies include one or more cameras for capturing imaging data of the track rail and a proximate area surrounding the track rail.

12. The method of claim 10, wherein the one or more sensor assemblies include sensors for identifying track rail and rail profile degradation and wear, said sensor including one or more of a LIDAR sensor, an ultrasonic sensor, an eddy current sensor and an electromagnetic field imaging sensor.

13. The method of claim 10, wherein the step of employing the one or sensor assemblies further comprises:
varying a frequency of sensing of the one or more sensor assemblies based upon a track variable associated with the track rail.

14. The method of claim 13, wherein the track variable is an event heavy track rail such that the frequency of sensing is increased.

15. The method of claim 14, wherein the event heavy track rail can include a rail location selected from a metropolitan location, a heavily traveled location, a heavily intersected location, a bend or curve location, a bridge location and a switchyard location.

16. The method of claim 15, wherein the frequency of sensing can be increased by identifying one or more geographical identifiers such as latitude and longitude, GPS and mile markers that are historically identified with event heavy track rail.

17. The method of claim 16, wherein the geographical identifiers are stored in a memory system.

18. The method of claim 1, further comprising:
capturing completion data with the second special grinding machine after specialized grinding is completed at the portion of the track rail requiring specialized grinding.

19. The method of claim 18, further comprising:
storing the completion data.

20. The method of claim 19, further comprising:
forwarding the completion data to an outside source for monitoring quality assurance.

21. The method of claim 19, further comprising:
building a historical database of the completion data at the portion of the track rail requiring specialized grinding.

22. The method of claim 21, further comprising:
analyzing the historical database of completion data to predict a need for future specialized grinding.

23. A system for enhanced rail grinding, the system comprising:
a first rail grinding machine, wherein the first rail grinding machine comprises:
a rail profiling assembly,
a sensor assembly configured to sense track rail,
a communication assembly,
a processing assembly configured to construct a virtual image; and
a second rail grinding machine, wherein the second rail grinding machine comprises:
a specialty profiling assembly,
a communication assembly,
a display assembly; and
wherein the first rail grinding machine is configured to identify a need for the second rail grinding machine at a first location, the first rail profile machine being further configured to assemble and communicate a virtual image of the first location to the second rail grinding machine; and
wherein, the second rail grinding machine is configured to receive the virtual image and the second rail grinding machine further proceeds to the first location to address a re-profiling need at the first location based on the virtual image; and
wherein the first rail grinding machine and the second rail grinding machine are configured to operate remotely.

24. The system according to claim 23, wherein the profiling assembly of the first rail grinding machine comprises at least one of a processor, a memory, a sensor, a sensor, a patterning engine, an event engine and a transmission engine.

25. The system according to claim 23, wherein the sensor assembly of the first rail grinding machine comprises at least one of a processor, a sensor and an image capture device.

26. The system according to claim 23, wherein the communication assembly of the first rail grinding machine comprises at least one of a processor and a transmission engine.

27. The system according to claim 23, wherein the processing assembly of the first rail grinding machine comprises at least one of a processor, a patterning engine and an event engine.

28. The system according to claim 23, wherein the specialty profiling assembly of the second rail grinding assembly comprises at least one of a processor, a memory, a display engine and an input/output engine.

29. The system according to claim 23, wherein the communication assembly of the second rail grinding assembly comprises at least one of a processor, a display engine and an input/output engine.

30. The system according to claim 23, wherein the display assembly of the second rail grinding assembly comprises at least one of a processor, a display engine and an input/output engine.

31. The system according to claim 23, wherein the first rail grinding machine is configured to detect a change in a track rail at a location along a length of rail.

32. The system according to claim 31, wherein the change of the track rail is detected by comparing a sensed and/or captured image with a stored list of conditions.

33. The system according to claim 32, wherein the list of conditions comprises a defined set of tolerances and/or variances for the track rail.

34. The system according to claim 33, wherein a detected change falling inside or outside the defined set of tolerances and/or variances triggers creation of an event.

35. The system according to claim 34, wherein the event is identified with a location of the track rail.

36. The system according to claim 23, wherein the virtual image is assembled from one or more of a track rail condition at the first location, GPS data of the first location, track rail conditions external to the first location and longitude and latitude of the first location.

37. The system according to claim 23, wherein the virtual image is a two-dimensional representation of the first location.

38. The system according to claim 23, wherein the virtual image is a three-dimensional representation of the first location.

39. The system according to claim 23, wherein the virtual image is displayed to an operator on one or more of a display screen, VR device, AR device, mixed reality device, PID and computer monitor.
